(19) United States
(12) Patent Application Publication
(10) Pub. No.: US 2025/0070408 A1
(43) Pub. Date: Feb. 27, 2025

(54) SECONDARY BATTERY

(71) Applicant: SAMSUNG SDI CO., LTD., Yongin-si (KR)

(72) Inventors: Chan Ho LEE, Yongin-si (KR); Sang Hoon KIM, Yongin-si (KR); Kwang Soo BAE, Yongin-si (KR)

(21) Appl. No.: 18/545,085

(22) Filed: Dec. 19, 2023

(30) Foreign Application Priority Data
Aug. 23, 2023 (KR) 10-2023-0110477

(51) Int. Cl. H01M 50/533; H01M 50/103; H01M 50/176; H01M 50/54

(52) U.S. Cl. CPC H01M 50/533; H01M 50/103; H01M 50/176; H01M 50/54

(57) ABSTRACT

A secondary battery includes: an electrode assembly including: first and second electrode plates respectively including a main tab close to an outer edge based on a center line in a longitudinal direction and a sub tab that is closer to the center line than to the outer edge; a first current collector electrically coupled to the first main tab and the first sub tab; a second current collector electrically coupled to the second main tab and the second sub tab; and a case configured to accommodate the electrode assembly, the first current collector, and the second current collector. The first main tab and the second sub tab have an asymmetric shape, and the second main tab and the second sub tab have an asymmetric shape.

### CROSS-REFERENCE TO RELATED APPLICATION

The present application claims priority to and the benefit of Korean Patent

Application No. 10-2023-0110477, filed on Aug. 23, 2023, in the Korean Intellectual Property Office, the entire disclosure of which is incorporated herein by reference.

BACKGROUND

### 1. Field

Aspects of embodiments of the present disclosure relate to a secondary battery.

### 2. Description of the Related Art

Secondary batteries are designed to be rechargeable, unlike primary batteries. In these secondary batteries, a low capacity battery including a battery cell in the form of a pack may be used in portable small electronic devices, such as smartphones and digital cameras, and a high capacity battery module including tens to hundreds of battery packs connected to each other may be used as a power source for driving motors, e.g., of hybrid vehicles, electric vehicles, and the like.

A rechargeable secondary battery generally includes an electrode assembly

in which a separator is interposed between a positive electrode plate and a negative electrode plate, a current collector plate electrically connected to the electrode assembly, a terminal electrically connected to the current collector plate, a case accommodating the electrode assembly and the current collector plate, and a cap plate, which seals the case and through which the terminal passes to be coupled to an external device.

The above-described information serves as the background of the present disclosure and is for improving understanding of the background of the present disclosure and, thus, may include information that does not constitute the related (or prior) art.

### SUMMARY

Embodiments of the present disclosure provide a secondary battery that reduces or avoids non-uniform deterioration and improves current flow.

According to an embodiment of the present disclosure, a secondary battery includes: an electrode assembly including: a first electrode plate including a first main tab close to a first outer edge based on a center line in a longitudinal direction and a first sub tab that is closer to the center line than to the first outer edge; and a second electrode plate including a second main tab close to a second outer edge based on the center line in the longitudinal direction and a second sub tab that is closer to the center line than to the second outer edge; a first current collector electrically coupled to the first main tab and the first sub tab; a second current collector electrically coupled to the second main tab and the second sub tab; and a case configured to accommodate the electrode assembly, the first current collector, and the second current collector. The first main tab and the second sub tab have an asymmetric shape, and the second main tab and the second sub tab have an asymmetric shape.

An electrical resistance of the first main tab may be less than that of the first sub tab.

A surface area of the first main tab may be greater than that of the first sub tab.

A width of the first main tab may be greater than that of the first sub tab.

An electrical resistance of the second main tab may be less than that of the second sub tab.

A surface area of the second main tab may be greater than that of the second sub tab.

A width of the second main tab may be greater than that of the second sub tab.

The secondary battery may further include a first terminal electrically coupled to the first current collector and passing through the case. The first current collector may have: a first through-hole through which the first terminal passes; a first main area at one side of the first through-hole and electrically coupled to the first main tab; and a first sub area at another side of the first through-hole and electrically coupled to the first sub tab.

A surface area of the first main area may be greater than that of the first sub area.

The secondary battery may further include a second terminal electrically coupled to the second current collector and passing through the case. The second current collector may have: a second through-hole through which the second terminal passes; a second main area at one side of the second through-hole and electrically coupled to the second main tab; and a second sub area at another side of the second through-hole and electrically coupled to the second sub tab.

A surface area of the second main area may be greater than that of the second sub area.

The first electrode plate may include a first conductive base material and a first active material on the first conductive base material, and the first electrode plate may have: a first area that is relatively close to the first main tab and the first sub tab and a second area that is relatively far from the first main tab and the first sub tab based on a center line in a width direction. An electrical resistance of the first area may be greater than that of the second area.

A thickness of the first conductive base material at the first area may be less than that of the first conductive base material at the second area.

A thickness of the first active material at the first area may be less than that of the first active material at the second area.

A concentration of a conductive material of the first active material at the first area may be less than that of a conductive material of the first active material at the second area.

The second electrode plate may include a second conductive base material

and a second active material on the second conductive base material, and the second electrode plate may have: a first area that is relatively close to the second main tab and the second sub tab and a second area that is relatively far from the second main tab and the second sub tab based on a center line in a width direction. An electrical resistance of the first area may be greater than that of the second area.

A thickness of the second conductive base material at the first area may be less than that of the second conductive base material at the second area.

A thickness of the second active material at the first area may be less than that of the second active material at the second area.

A concentration of a conductive material of the second active material at the

first area may be less than that of a conductive material of the second active material at the second area.

The electrode assembly may have a vertical length that is greater than a horizontal width.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, describe aspects and features of the present disclosure.

In the drawings:

FIG. 1 is a perspective view of a secondary battery according to embodiments;

FIG. 2 is a cross-sectional view of the secondary battery shown in FIG. 1;

FIG. 3 is a plan view of an electrode assembly in the secondary battery shown in FIG. 1;

FIGS. 4A and 4B are cross-sectional views of a first electrode plate in an electrode assembly according to embodiments; and

FIGS. 5A and 5B are cross-sectional views of a second electrode plate in an electrode assembly according to embodiments.

### DETAILED DESCRIPTION

Hereinafter, embodiments of the present disclosure will be described in detail with reference to the accompanying drawings. The present disclosures may, however, be embodied in many different forms and should not be construed as being limited to the embodiments set forth herein. Rather, these embodiments are provided so that this disclosure will be thorough and complete and will fully convey the scope of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,”

“upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

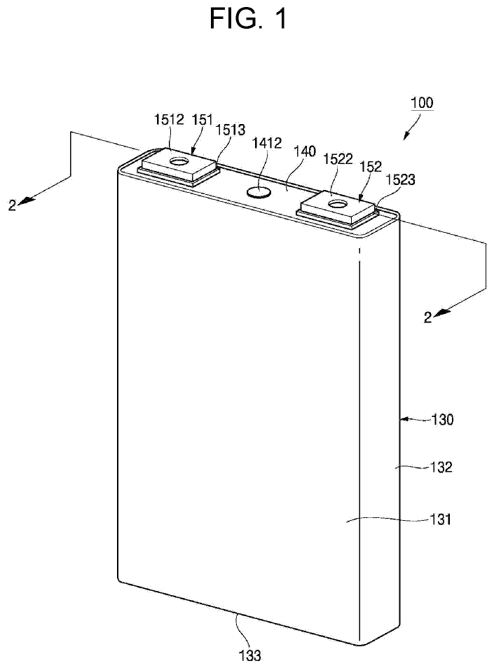

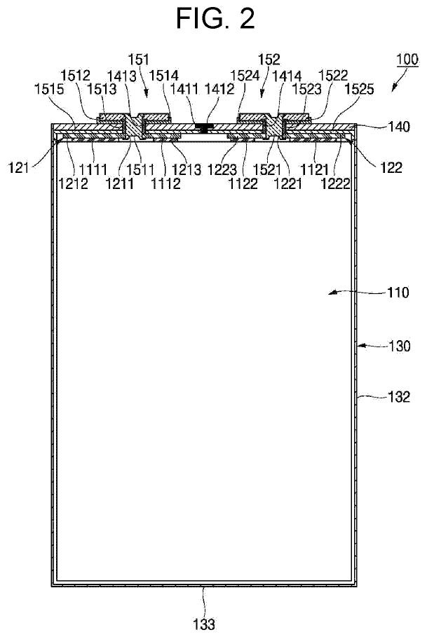

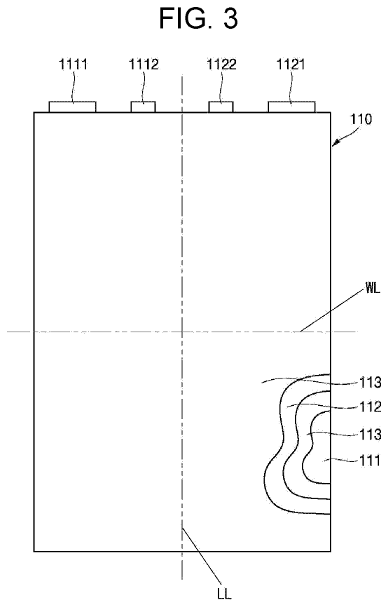

FIG. 1 is a perspective view of a secondary battery 100 according to embodiments, FIG. 2 is a cross-sectional view of the secondary battery 100 according to embodiments, and FIG. 3 is a plan view of an electrode assembly in the secondary battery 100 according to embodiments.

As illustrated in FIGS. 1 to 3, the secondary battery 100, according to embodiments of the present disclosure, may include an electrode assembly 110, a first current collector 121, a second current collector 122, and a case 130.

In some embodiments, the secondary battery 100, according to embodiments of the present disclosure, may further include a cap plate 140.

In some embodiments, the secondary battery 100, according to embodiments of the present disclosure, may further include a first terminal 151 and a second terminal 152.

The electrode assembly 110 may have a substantially rectangular hexahedral shape having a pair of long sides in a longitudinal direction and a pair of short sides in the longitudinal direction. In some embodiments, a surface area of each of the long sides may be larger (or wider) than that of each of the short sides. In some embodiments, the long side and/or the short side may have a length and a width. In some embodiments, the length may be longer than the width. In some embodiments, the length may be in a range of approximately 200 mm to approximately 400 mm.

In some embodiments, the electrode assembly 110 may include a first electrode plate 111 (e.g., a positive electrode plate), a second electrode plate 112 (e.g., a negative electrode plate), and a separator 113 between the first electrode plate 111 and a second electrode plate 112. In some embodiments, the first electrode plate 111 may include a first main tab 1111 (e.g., positive electrode tab) and a first sub tab 1112 (e.g., positive electrode tab), which protrude to the outside (e.g., upper side) of the electrode assembly 110, and the second electrode plate 112 may include a second main tab 1121 (e.g., negative electrode tab) and a second sub tab 1122 (e.g., negative electrode tab), which protrude to the outside (e.g., upper side) of the electrode assembly 110. In some embodiments, the first electrode plate 111 may include a first main tab 1111 that is close to a first outer edge (e.g., left outer edge) of the electrode assembly 110 and a first sub tab 1112 that is closer to the center line LL of the electrode assembly 110 than to the first outer edge based on a longitudinal center line

LL. In some embodiments, the first main tab 1111 and the first sub tab 1112 may be base material tabs extending from the first electrode plate 111, respectively. In some embodiments, the second electrode plate 112 may include a second main tab 1121 that is close to a second outer edge (e.g., right outer edge) of the electrode assembly 110 and a second sub tab 1122 that is closer to the center line LL than to the second outer edge based on the longitudinal center line LL. In some embodiments, the second main tab 1121 and the second sub tab 1122 may be base material tabs extending from the second electrode plate 112, respectively. In some embodiments, the electrode assembly 110 may be a stack type electrode assembly in which the first electrode plate 111, the separator 113, and the second electrode plate 112 are stacked, or a winding type electrode assembly in which the first electrode plate 111, the separator 113, and the second electrode plate 112 are wound. In some embodiments, the electrode assembly 110 may include or may be referred to as an electrode group.

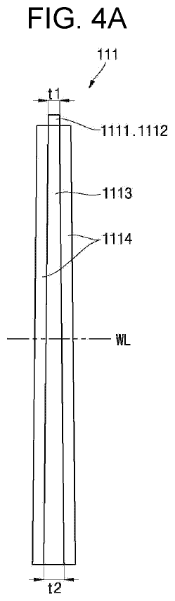

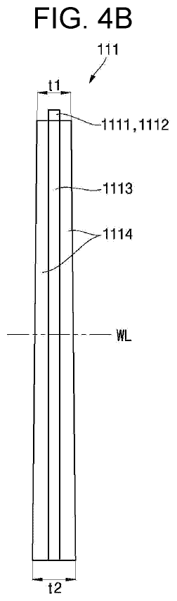

In some embodiments, the first electrode plate 111 may be formed (or provided) by applying a first active material 1114, such as a transition metal oxide, to a first conductive base material 1113 made of metal foil, such as aluminum (see, e.g., FIGS. 4A and FIG. 4B) and may include the first main tab 1111 and the first sub tab 1112 (e.g., areas that are not coated with the first active material 1114) extending and protruding toward the cap plate 140 of the first conductive base material 1113. The first main tab 1111 and the first sub tab 1112 that extend and protrude in this manner may also be referred to as a non-coating (or non-coated) portion tab or a base material tab, and the first main tab 1111 and the first sub tab 1112 may be aligned at the same position through the staking or winding process for manufacturing the electrode assembly 110 to provide a multi-tab arrangement. The first main tab 1111 and the first sub tab 1112 may be electrically connected to the first terminal 151 to act as a passage through which current flows between the first electrode plate 111 and the first terminal 151.

In some embodiments, the second electrode plate 112 may be provided by applying a second active material 1124, such as graphite or carbon, to a second conductive base material 1123 made of metal foil, such as copper or nickel (see, e.g.,

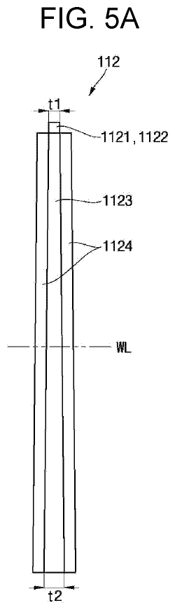

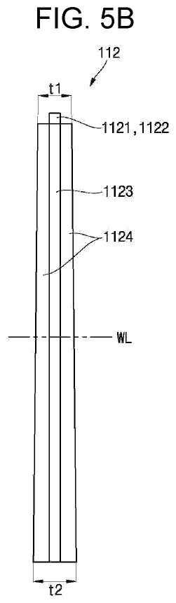

FIGS. 5A and FIG. 5B) and may include the second main tab 1121 and the second sub tab 1122 (e.g., areas that are not coated with the second active material 1124) extending and protruding toward the cap plate 140 of the second conductive base material 1123. The second main tab 1121 and the second sub tab 1122 that extend and protrude in this manner may also be referred to as a non-coating (or non-coated) portion tab or a base material tab, and the second main tab 1121 and the second sub tab 1122 may be aligned at the same position through the staking or winding process for manufacturing the electrode assembly 110 to provide a multi-tab arrangement. The second main tab 1121 and the second sub tab 1122 may be electrically connected to the second terminal 152 to act as a passage through which current flows between the second electrode plate 112 and the second terminal 152.

In some embodiments, the first main tab 1111 and the first sub tab 1112 may have an asymmetric shape. In some embodiments, the second main tab 1121 and the second sub tab 1122 may have an asymmetric shape. The term “asymmetric” may mean that shapes, sizes, lengths, and/or widths of the tabs are not the same as and are different from each other.

In some embodiments, electrical resistance of the first main tab 1111 may be less than that of the first sub tab 1112. In some embodiments, a horizontal surface area of the first main tab 1111 may be greater than that of the first sub tab 1112. In some embodiments, a horizontal width of the first main tab 1111 may be greater than that of the first sub tab 1112.

In some embodiments, electrical resistance of the second main tab 1121 may be less than that of the second sub tab 1122. In some embodiments, a horizontal surface area of the second main tab 1121 may be greater than that of the second sub tab 1122. In some embodiments, a horizontal width of the second main tab 1121 may be greater than that of the second sub tab 1122.

As a result, in the present disclosure, the electrical resistance of the current path flowing from the first main tab 1111 to the second main tab 1121 (or from the second main tab 1121 to the first main tab 1111) may be reduced due to the current path flowing from the first sub tab 1112 to the second sub tab 1122 (or from the second sub tab 1122 to the first sub tab 1112). In some embodiments, because the current path within the electrode assembly 110 is provided (or spread) over a wide area rather than being concentrated to some narrow areas, non-uniform deterioration of the battery may be suppressed.

The separator 113 may be interposed between the first electrode plate 111 and the second electrode plate 112 to prevent short circuit between the first electrode plate 111 and the second electrode plate 112 and to enable the movement of lithium ions therebetween. The separator 113 may be slightly wider than the surface area of each of the first electrode plate 111 and the second electrode plate 112 to further protrude in an upward and downward direction and/or a left and right direction than (e.g., to protrude beyond edges of) each of the first electrode plate 111 and the second electrode plate 112. In some embodiments, the separator 113 may prevent the first electrode plate 111 and the second electrode plate 112 from being in direct contact with the case 130 and the cap plate 140 in the upward and downward direction and/or left and right direction of the electrode assembly 110.

In some embodiments, the electrode assembly 110 may be accommodated

in the case 130 together with an electrolyte. In some embodiments, the electrolyte may include an organic solvent, such as ethylene carbonate (EC), propylene carbonate (PC), diethyl carbonate (DEC), ethyl methyl carbonate (EMC), and/or dimethyl carbonate (DMC), and a lithium salt, such as LiPF₆ or LiBF₄. In some embodiments, the electrolyte may be a liquid, solid, or gel.

The first current collector 121 may be interposed between the electrode assembly 110 and the cap plate 140. In some embodiments, the first current collector 121 may have a substantially rectangular plate shape. The first current collector 121 may electrically/mechanically couple the first main tab 1111 and the first sub tab 1112 of the electrode assembly 110 to the first terminal 151. In some embodiments, the first current collector 121 may have a first through-hole 1211, through which the first terminal 151 passes, a first main area 1212, which is one side of the first through-hole 1211 and to which the first main tab 1111 is electrically coupled, and a first sub area 1213, which is the other side of the first through-hole 1211 and to which the first sub tab 1112 is electrically coupled. In some embodiments, after the first terminal 151 passes through the first through-hole 1211 in the first current collector 121, the first terminal 151 may be riveted to the first current collector 121. In some embodiments, the first main tab 1111 may be laser welded to the first main area 1212 of the first current collector 121. In some embodiments, the first sub tab 1112 may be laser welded to the first sub area 1213 of the first current collector 121. In some embodiments, a surface area of the first main area 1212 may be wider than that of the first sub area 1213. In some embodiments, the first current collector 121 may be made of a conductive metal, such as aluminum, an aluminum alloy, or nickel-plated steel, and may also be referred to as a sub plate.

The second current collector 122 may be interposed between the electrode assembly 110 and the cap plate 140. In some embodiments, the second current collector 122 may have a substantially rectangular plate shape. The second current collector 122 may electrically/mechanically couple each of the second main tab 1121 and the second sub tab 1122 of the electrode assembly 110 to the second terminal 152. In some embodiments, the second current collector 122 may have a second through-hole 1221, through which the second terminal 152 passes, a second main area 1222, which is one side of the second through-hole 1221 and to which the second main tab 1121 is electrically coupled, and a second sub area 1223, which is the other side of the second through-hole 1221 and to which the second sub tab 1122 is electrically coupled. In some embodiments, after the second terminal 152 passes through the second through-hole 1221 in the second current collector 122, the second terminal 152 may be riveted to the second current collector 122. In some embodiments, the second main tab 1121 may be laser welded to the second main area 1222 of the second current collector 122. In some embodiments, the second sub tab 1122 may be laser welded to the second sub area 1223 of the second current collector 122. In some embodiments, a surface area of the second main area 1222 may be wider than that of the second sub area 1223. In some embodiments, the second current collector 122 may be made of a conductive metal, such as copper, a copper alloy, nickel, a nickel alloy, or nickel-plated steel, and may also be referred to as a sub plate.

The case 130 may accommodate the electrode assembly 110. In some embodiments, the case 130 may be in the form of a can having an open upper portion and closed lower and side portions. In some embodiments, the case 130 may have an approximately rectangular hexahedral shape having a pair of long side parts 131 in the longitudinal direction, a pair of short side parts 132 in the longitudinal direction, and a bottom part 133 in the width direction. In some embodiments, a surface area of each of the long side parts 131 may be wider than that of each of the short side parts 132. In some embodiments, each of the long side part 131 and/or the short side part 132 may have a length and a width. In some embodiments, the length may be greater than the width. In some embodiments, the length may be in a range of approximately 200 mm to approximately 400 mm. In some embodiments, the case 130 may be provided by a deep drawing manner of placing a metal sheet on a mold or die and then pressing the metal sheet through a punch. In some embodiments, the case 130 may be formed (or provided) by bending a metal plate into a rectangular hexahedral shape and then laser welding ends to each other. In some embodiments, the case 130 may be formed (or provided) by extruding molten metal into a tube shape. In some embodiments, the case 130 may be made of a conductive metal, such as aluminum, an aluminum alloy, or nickel-plated steel. In some embodiments, the case 130 may include or may be referred to as a can. In some embodiments, the long side part 131 of the case 130 may be in close contact with the long side part of the electrode assembly 110, and the short side part 132 of the case 130 may be in close contact with the short side part of the electrode assembly 110.

The cap plate 140 may have a substantially rectangular plate shape and may be coupled to an upper opening of the case 130. In some embodiments, the cap plate 140 may close (e.g., may seal) an opening in case 130 and may be laser welded to the case 130. In some embodiments, the cap plate 140 may have a vent hole 1411 provided approximately at the center thereof and a safety vent 1412 that blocks the vent hole 1411. In some embodiments, the first terminal 151 electrically coupled to the first main tab 1111 and the first sub tab 1112 of the electrode assembly 110 may be insulated from and coupled to pass through the cap plate 140. The cap plate 140 may have a first terminal hole 1413 through which the first terminal 151 is coupled. In some embodiments, the second terminal 152 electrically coupled to the second main tab 1121 and the second sub tab 1122 of the electrode assembly 110 may be insulated from and coupled to pass through the cap plate 140. The cap plate 140 may have a second terminal hole 1414 through which the second terminal 152 is coupled. In some embodiments, the cap plate 140 may be made of a conductive metal, such as aluminum, an aluminum alloy, or nickel-plated steel, and may also be referred to as a cap assembly.

The first terminal 151 may be coupled to pass through the first terminal hole 1413 in the cap plate 140. In some embodiments, the first terminal 151 may include a first terminal pillar 1511 and a first terminal plate 1512. A lower portion of the first terminal pillar 1511 may be riveted through the first through-hole 1211 in the first current collector 121. An upper portion of the first terminal pillar 1511 may be coupled to pass through the first terminal plate 1512 and may be riveted. In some embodiments, a first insulating gasket 1513 may be provided to insulate the first terminal pillar 1511 from the cap plate 140. In some embodiments, a first upper insulating member 1514 may be provided to insulate the first terminal plate 1512 from the cap plate 140. In some embodiments, a first lower insulating member 1515 may be provided to insulate the first current collector 121 from the cap plate 140. In some embodiments, the first terminal pillar 1511 may pass through the first insulating gasket 1513, and the first terminal plate 1512 may be disposed on the first insulating gasket 1513 and the first upper insulating member 1514, and thus, the first terminal 151 may be insulated from the cap plate 140. In some embodiments, the first terminal 151, that is, the first terminal pillar 1511 and the first terminal plate 1512, may be made of a conductive metal, such as aluminum, an aluminum alloy, or nickel-plated steel. In some embodiments, the first insulating gasket 1513, the first upper insulating member 1514, and the first lower insulating member 1515 may be made of polyethylene (PE), polypropylene (PP), double synthetic rubber (EPDM), or nylon.

The second terminal 152 may be coupled to pass through the second terminal hole 1414 in the cap plate 140. In some embodiments, the second terminal 152 may include a second terminal pillar 1521 and a second terminal plate 1522. A lower portion of the second terminal pillar 1521 may be riveted to pass through the second through-hole 1221 in the second current collector 122. An upper portion of the second terminal pillar 1521 may be coupled to pass through the second terminal plate 1522 and may be riveted. In some embodiments, a second insulating gasket 1523 may be provided to insulate the second terminal pillar 1521 from the cap plate 140. In some embodiments, a second upper insulating member 1524 may be provided to insulate the second terminal plate 1522 from the cap plate 140. In some embodiments, a second lower insulating member 1525 may be provided to insulate the second current collector 122 from the cap plate 140. In some embodiments, the second terminal pillar 1521 may pass through the second insulating gasket 1523, and the second terminal plate 1522 may be disposed on the second insulating gasket 1523 and the second upper insulating member 1524, and thus, the second terminal 152 may be insulated from the cap plate 140. In some embodiments, the second terminal pillar 1521 may be made of a conductive metal, such as copper, a copper alloy, nickel, nickel alloy, or nickel-plated steel. In some embodiments, the second terminal plate 1522 may be made of a conductive metal, such as aluminum, an aluminum alloy, or nickel-plated steel. In some embodiments, each of the second insulating gasket 1523, the second upper insulating member 1524, and the second lower insulating member 1525 may include PP, PE, or EPDM.

Accordingly, the secondary battery 100, according to embodiments of the present disclosure, reduces or avoids a non-uniform deterioration phenomenon that can occur during charging and discharging of the secondary battery by providing the asymmetric electrode tab structure and provides improved a current flow. In some embodiments, the electrode tab structure may be provided in an asymmetric form in the longitudinal direction of the battery to provide the secondary battery 100, according to embodiments of the present disclosure, that reduces a non-uniform deterioration phenomenon that can occur during charging and discharging of the secondary battery by applying the asymmetric electrode tab structure and provides improved current flow.

FIGS. 4A and 4B are cross-sectional views of the first electrode plate 111 in the electrode assembly 110 according to embodiments. In the drawings, a thickness of the electrode plate is exaggerated for ease of understanding.

In some embodiments, the first electrode plate 111 may include a first conductive base material 1113 and a first active material 1114 applied on the first conductive base material 1113. In some embodiments, the first electrode plate 111 may have a first area (e.g., an upper area) that is relatively close to the first main tab 1111 and the first sub tab 1112 and a second area (e.g., a lower area) that is relatively far from the first main tab 1111 and the first sub tab 1112 based on a center line WL in the width direction.

In some embodiments, as illustrated in, for example, FIG. 4A, a thickness t1 of the first conductive base material 1113 corresponding to the first area may be less than a thickness t2 of the first conductive base material 1113 corresponding to the second area, and thus, electrical resistance at the first area may be greater than at the second area.

In some embodiments, as illustrated in, for example, FIG. 4B, the thickness t1 of the first active material 1114 corresponding to the first area may be less than the thickness t2 of the first active material 1114 corresponding to the second area, and thus, electrical resistance at the first area may be greater than at the second area.

In some embodiments, because a concentration of the conductive material in the first active material 1114 corresponding to the first area may be less than that of the conductive material in the first active material 1114 corresponding to the second area, electrical resistance at the first area may be greater than at the second area.

FIGS. 5A and 5B are cross-sectional views of a second electrode plate in the electrode assembly according to embodiments. In the drawings, a thickness of the electrode plate is exaggerated for ease of understanding.

In some embodiments, the second electrode plate 112 may include a second conductive base material 1123 and a second active material 1124 applied on the second conductive base material 1123. In some embodiments, the second electrode plate 112 may have a first area (e.g., an upper area) that is relatively close to the second main tab 1121 and the second sub tab 1122 and a second area (e.g., a lower area) that is relatively far from the second main tab 1121 and the second sub tab 1122 based on the center line WL in the width direction.

In some embodiments, as illustrated in, for example, FIG. 5A, a thickness t1 of the second conductive base material 1123 corresponding to the first area may be less than a thickness t2 of the second conductive base material 1123 corresponding to the second area, and thus, electrical resistance at the first area may be greater than at the second area.

In some embodiments, as illustrated in, for example, FIG. 5B, the thickness t1 of the second active material 1124 corresponding to the first area may be less than the thickness t2 of the second active material 1124 corresponding to the second area, and thus, electrical resistance at the first area may be greater than at the second area.

In some embodiments, a concentration of the conductive material in the second active material 1124 corresponding to the first area may be less than that of the conductive material in the second active material 1124 corresponding to the second area, and thus, electrical resistance at the first area may be greater than at the second area.

In this manner, embodiments of the present disclosure provide a secondary battery that reduces or avoids a non-uniform deterioration phenomenon by providing the asymmetric electrode plate structure and provides improved current flow. In some embodiments, the electrode plate structure may be provided in the asymmetric form in the width direction of the battery to provide a secondary battery that reduces or avoids a non-uniform deterioration phenomenon by applying the asymmetric electrode tab structure and provides improved current flow.

Embodiments of the present disclosure may provide a secondary battery that reduces or avoids the non-uniform deterioration by applying the asymmetric electrode tab structure and/or the asymmetric electrode plate structure and provides improved current flow. In some embodiments, a secondary battery in which the electrode tab structure is provided in the asymmetric form in the longitudinal direction of the battery and/or the electrode plate structure is provided in the asymmetric form in the width direction of the battery to reduce or avoid the non-uniform deterioration phenomenon and to improve current flow may be provided.

The above-mentioned embodiments are merely some embodiments of the secondary battery, and thus, the present disclosure is not limited to the foregoing embodiments. Also, it will be understood by those of ordinary skill in the art that various changes in form and details may be made therein without departing from the spirit and scope of the present disclosure as defined by the following claims and their equivalents.

What is claimed is:

1. A secondary battery comprising:
an electrode assembly comprising:
a first electrode plate comprising a first main tab close to a first outer edge based on a center line in a longitudinal direction and a first sub tab that is closer to the center line than to the first outer edge; and
a second electrode plate comprising a second main tab close to a second outer edge based on the center line in the longitudinal direction and a second sub tab that is closer to the center line than to the second outer edge;
a first current collector electrically coupled to the first main tab and the first sub tab;
a second current collector electrically coupled to the second main tab and the second sub tab; and
a case configured to accommodate the electrode assembly, the first current collector, and the second current collector,
wherein the first main tab and the second sub tab have an asymmetric shape, and the second main tab and the second sub tab have an asymmetric shape.

2. The secondary battery as claimed in claim 1, wherein an electrical resistance of the first main tab is less than that of the first sub tab.

3. The secondary battery as claimed in claim 1, wherein a surface area of the first main tab is greater than that of the first sub tab.

4. The secondary battery as claimed in claim 1, wherein a width of the first main tab is greater than that of the first sub tab.

5. The secondary battery as claimed in claim 1, wherein an electrical resistance of the second main tab is less than that of the second sub tab.

6. The secondary battery as claimed in claim 1, wherein a surface area of the second main tab is greater than that of the second sub tab.

7. The secondary battery as claimed in claim 1, wherein a width of the second main tab is greater than that of the second sub tab.

8. The secondary battery as claimed in claim 1, further comprising a first terminal electrically coupled to the first current collector and passing through the case,
wherein the first current collector has:
a first through-hole through which the first terminal passes;
a first main area at one side of the first through-hole and electrically coupled to the first main tab; and
a first sub area at another side of the first through-hole and electrically coupled to the first sub tab.

9. The secondary battery as claimed in claim 8, wherein a surface area of the first main area is greater than that of the first sub area.

10. The secondary battery as claimed in claim 1, further comprising a second terminal electrically coupled to the second current collector and passing through the case,
wherein the second current collector has:
a second through-hole through which the second terminal passes;
a second main area at one side of the second through-hole and electrically coupled to the second main tab; and
a second sub area at another side of the second through-hole and electrically coupled to the second sub tab.

11. The secondary battery as claimed in claim 10, wherein a surface area of the second main area is greater than that of the second sub area.

12. The secondary battery as claimed in claim 1, wherein the first electrode plate comprises a first conductive base material and a first active material on the first conductive base material,
wherein the first electrode plate has a first area that is relatively close to the first main tab and the first sub tab and a second area that is relatively far from the first main tab and the first sub tab based on a center line in a width direction, and
wherein an electrical resistance of the first area is greater than that of the second area.

13. The secondary battery as claimed in claim 12, wherein a thickness of the first conductive base material at the first area is less than that of the first conductive base material at the second area.

14. The secondary battery as claimed in claim 12, wherein a thickness of the first active material at the first area is less than that of the first active material at the second area.

15. The secondary battery as claimed in claim 12, wherein a concentration of a conductive material of the first active material at the first area is less than that of a conductive material of the first active material at the second area.

16. The secondary battery as claimed in claim 1, wherein the second electrode plate comprises a second conductive base material and a second active material on the second conductive base material,
wherein the second electrode plate has a first area that is relatively close to the second main tab and the second sub tab and a second area that is relatively far from the second main tab and the second sub tab based on a center line in a width direction, and
wherein an electrical resistance of the first area is greater than that of the second area.

17. The secondary battery as claimed in claim 16, wherein a thickness of the second conductive base material at the first area is less than that of the second conductive base material at the second area.

18. The secondary battery as claimed in claim 16, wherein a thickness of the second active material at the first area is less than that of the second active material at the second area.

19. The secondary battery as claimed in claim 16, wherein a concentration of a conductive material of the second active material at the first area is less than that of a conductive material of the second active material at the second area.

20. The secondary battery as claimed in claim 1, wherein the electrode assembly has a vertical length that is greater than a horizontal width.
